(19) United States
(12) Patent Application Publication
(10) Pub. No.: US 2013/0327268 A1
(43) Pub. Date: Dec. 12, 2013

(54) PAPER FEEDER FOR COMPACT PRINTER AND PRINTER WITH PAPER FEEDER

(71) Applicant: HON HAI PRECISION INDUSTRY CO., LTD., New Taipei (TW)

(72) Inventor: CHANG-LUNG YU, New Taipei (TW)

(73) Assignee: HON HAI PRECISION INDUSTRY CO., LTD., New Taipei (TW)

(21) Appl. No.: 13/862,639

(22) Filed: Apr. 15, 2013

(30) Foreign Application Priority Data
Jun. 8, 2012 (TW) 101120824

(51) Int. Cl. B41J 13/00

(52) U.S. Cl. CPC B41J 13/0018
USPC 118/300; 118/500

(57) ABSTRACT

A paper feeder enables a compact printer to print a large area of paper. The paper feeder includes a hanger, a paper feeding module, a driving module and a controller. The feeding module includes a tray and a roller. The tray includes a paper input board and a paper output board. The roller is located in the tray and feeds a paper from the paper input board to the paper output board. The driving module includes a base configured to receive the compact printer and a driving device which drives the base to move across the moving direction of the paper. The controller is configured to control the compact printer to print on the paper at a certain location.

### BACKGROUND

The disclosure generally relates to a paper feeder for a compact printer and printer with the paper feeder.

### DESCRIPTION OF RELATED ART

A compact printer integral with a ink cartridge is portable to work out of the office. In use, the compact printer is held by hand to print when stands on paper without lateral movement. A width of printing area of the compact printer is small and is restricted by sizes of ink heads of the compact printer. Thus, large area printing cannot be done with the compact printer. There is a need for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of a printer in one embodiment.

FIG. 2 is an assembly view of the printer of FIG. 1.

FIG. 3 is similar to FIG. 2, but showing a working state of the printer.

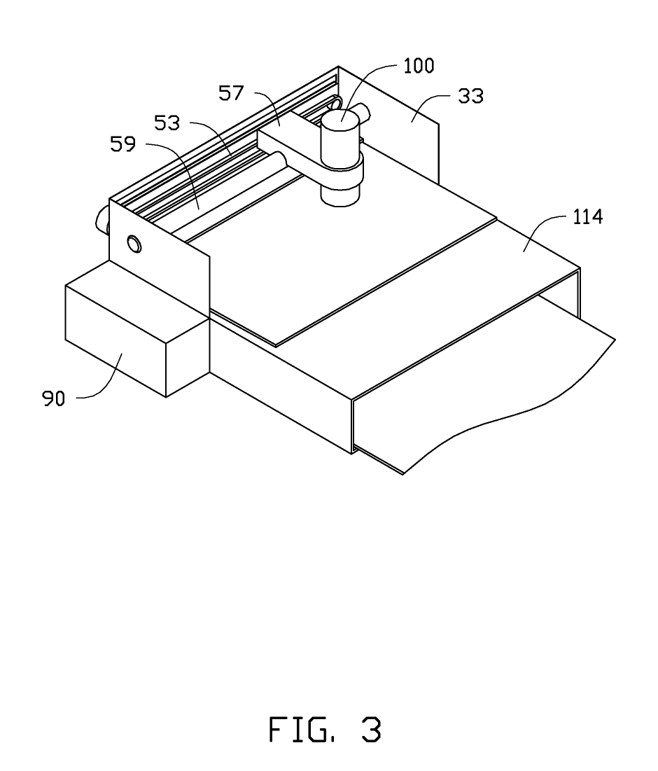

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

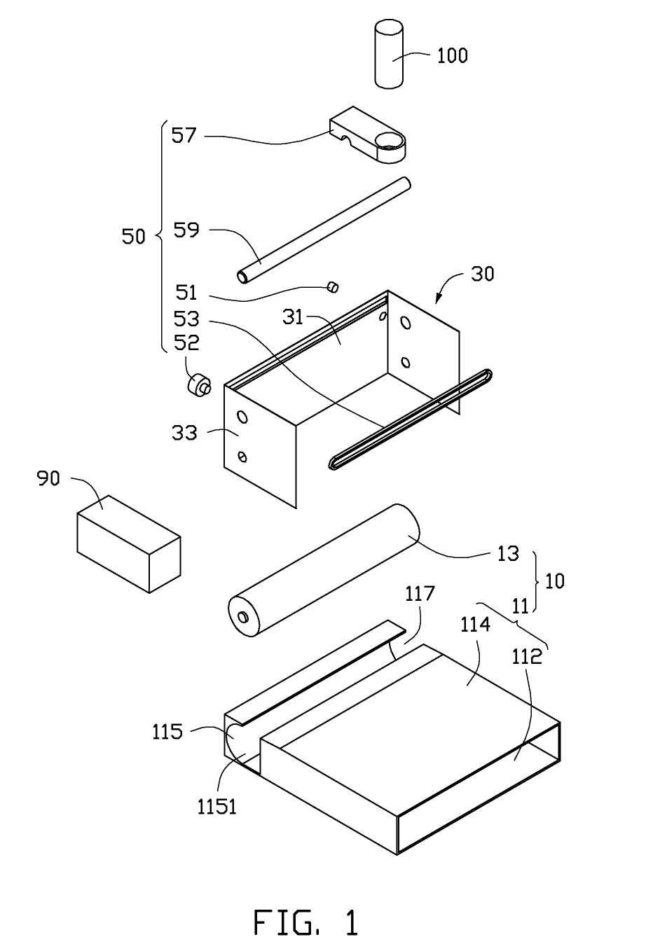

FIG. 1 illustrates one embodiment of a printer which includes a compact printer 100 and a paper feeder for controlling the compact printer 100 to print on a paper. The compact printer 100 can work as a mini printer to print paper.

The paper feeder includes a paper feeding module 10, a hanger 30, a driving module and a controller 90.

The paper feeding module 10 includes a tray 11 and a roller 13. The tray 11 includes a paper input board 112, a paper output board 114, and a guiding portion 115. The paper output board 114 is located on top of the paper input board 112. The paper output board 14 is substantially parallel to the paper input board 112. A space is defined between paper output board 114 and the paper input board 112 to store papers for printing. The guiding portion 115 is located on one side of the paper input board 112 and the paper output board 114. The guiding portion 115 includes an arcuate guiding inner surface 1151. A feeding opening 117 is defined between the paper output board 114 and the guiding portion 115. The roller 13 is located in the inner surface 1151 of the guiding portion 115. Two side openings are defined on opposite sides of the guiding portion 115.

The hanger 30 includes a rear wall 31 and two side walls 33. The two side walls 33 are parallel to each other. The hanger 30 is substantially U-shaped.

The driving module 50 includes a first post 51, a second post 52, a driving device 53, a base 57 and a rod 59. The first post 51 and the second post 52 are rotatably mounted to the rear wall 31. The driving device 53 can be an endless driving belt. The driving device 53 loops around the first post 51 and the second post 52 and is driven by rotation of the first post 51 and the second post 52. The base 57 receives the compact printer 100.

The controller 90 controls and coordinates the working of the roller 13, the second post 52 and the compact printer 100.

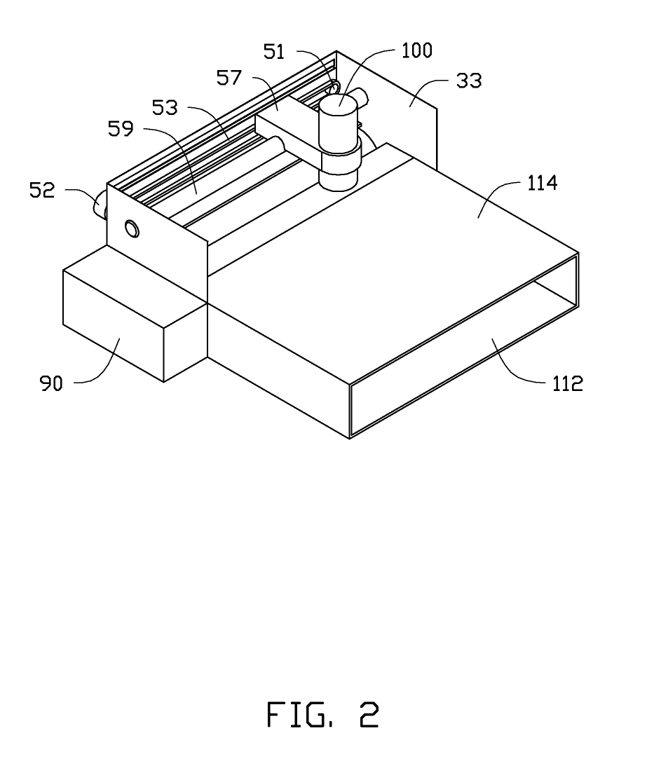

Referring to FIG. 2, in assembly, the tray 11 is mounted to the hanger 30, one side of the tray 11 is located between the two side walls 33. The roller 13 is attached to the two side walls 33 and rotates in the tray 11. The driving device 53 is movably attached to the rear wall 31 through the first post 51 and the second post 52. The rod 59 extends through the two side walls 33. The base 57 is positioned on the rod 59. One end of the base 57 is mounted to the driving device 53. The compact printer 100 is mounted to the other end of the base 57. The compact printer 100 is located on top of the paper output board 114. The controller 90 is located on one of the side walls 33.

In use, a plurality of sheets of paper is located on the paper input board 112, the controller 90 controls the roller 13 to rotate. One sheet of paper is caught by the roller 13 and is delivered to the feeding opening 117 through the guiding inner surface 1151. The controller 90 controls the compact printer 100 to print on the paper, and it controls the driving device 53 to move along a linear direction to couple with the compact printer 100. The printed paper is output to the paper output board 114. Thus, a wider printing area becomes available when the compact printer 100 is applied to the paper feeder relative to the solo working of the compact printer 100.

It is to be understood, however, that even though numerous characteristics and advantages have been set forth in the foregoing description of embodiments, together with details of the structures and functions of the embodiments, the disclosure is illustrative only and changes may be made in detail, especially in matters of shape, size, and arrangement of parts within the principles of the disclosure to the full extent indicated by the broad general meaning of the terms in which the appended claims are expressed.

What is claimed is:

1. A paper feeder for controlling a compact printer to print on a paper, comprising:
a hanger;
a paper feeding module mounted to the hanger, the paper feeding module comprising a tray and a roller, the tray comprising a paper input board and a paper output board, and the roller located in the tray and being configured to feed a paper from the paper input board to the paper output board;
a driving module mounted to the hanger, the driving module comprising a base configured to receive the compact printer and a driving device configured to drive the base to move along a linear direction which substantially traverses to a moving direction of the paper; and
a controller configured to control the compact printer to print on the paper coupling with a location of the compact printer.

2. The paper feeder of claim 1, wherein the paper output board is substantially parallel to the paper input board.

3. The paper feeder of claim 1, wherein the tray further comprises a guiding portion, the guiding portion comprises an arcuate guiding inner surface, and the roller is located on the arcuate guiding inner surface.

4. The paper feeder of claim 3, wherein a feeding opening is defined between the guiding portion and the paper output board.

5. The paper feeder of claim 1, wherein the hanger comprises a rear wall and two parallel side walls, and the roller is rotatably attached to the two parallel side walls.

6. The paper feeder of claim 5, wherein the hanger is substantially U-shaped.

7. The paper feeder of claim 6, wherein the driving device is a driving belt, the driving device is movably attached to the rear wall, and the base is moved with the driving belt.

8. The paper feeder of claim 1, wherein the driving module further comprises a rod, and the base is configured to slide on the rod along the linear direction.

9. The paper feeder of claim 1, wherein the base is located on top of the paper output board.

10. A printer, comprising:
a compact printer; and
a paper feeder for controlling the compact printer to print on a paper, the paper feeder comprising:
a hanger;
a paper feeding module mounted to the hanger, the paper feeding module comprising a tray and a roller, the tray comprising a paper input board and a paper output board, and the roller located in the tray and being configured to feed a paper from the paper input board to the paper output board;
a driving module mounted to the hanger, the driving module comprising a base and a driving device, the compact printer located on the base, and the driving device configured to drive the base to move along a linear direction which substantially traverses to a moving direction of the paper; and
a controller configured to control the compact printer to print on the paper coupling with a location of the compact printer.

11. The printer of claim 10, wherein the paper output board is substantially parallel to the paper input board.

12. The printer of claim 10, wherein the tray further comprises a guiding portion, the guiding portion comprises an arcuate guiding inner surface, and the roller is located on the arcuate guiding inner surface.

13. The printer of claim 12, wherein a feeding opening is defined between the guiding portion and the paper output board.

14. The printer of claim 10, wherein the hanger comprising a rear wall and two parallel side walls, and the roller is rotatably attached to the two parallel side walls.

15. The printer of claim 14, wherein the hanger is substantially U-shaped.

16. The printer of claim 15, wherein the driving device is a driving belt, the driving device is movably attached to the rear wall, and the base is moved with the driving belt.

17. The printer of claim 10, wherein the driving module further comprises a rod, and the base is configured to slide on the rod along the linear direction.

18. The printer of claim 10, wherein the base is located on top of the paper output board.
